(19) United States
(12) Patent Application Publication
(10) Pub. No.: US 2025/0008988 A1
(43) Pub. Date: Jan. 9, 2025

(54) DEVICE AND METHOD FOR HEATING FOOD

(71) Applicant: ALBERT HANDTMANN MASCHINENFABRIK GMBH & CO. KG, Biberach (DE)

(72) Inventors: Peter BORKUS, Hösbach (DE); Martin BERGMANN, Hösbach (DE); Kevin EBERHARDT, Sachsen b. Ansbach (DE)

(21) Appl. No.: 18/705,421

(22) PCT Filed: Oct. 7, 2022
(86) PCT No.: PCT/EP2022/077897

§ 371 Date: Apr. 26, 2024

(30) Foreign Application Priority Data
Oct. 28, 2021 (EP) 21205404.3

(51) Int. Cl. A23L 3/22; A23L 5/10

(52) U.S. Cl. CPC A23L 3/22; A23L 5/15

(57) ABSTRACT

A device for heating and optionally cooking a food comprises a shaping tube, a filling slide which is guided in the shaping tube, a first cap associated with the filling slide, a second cap, where the two caps each have concave surfaces facing one another and defining a cavity between them, wherein the food can be fed to the cavity via the filling slide, and wherein the device is configured to heat the food by way of a heating apparatus. The device comprises an air valve at the second cap. Furthermore, a corresponding method for heating food.

The invention relates to a device and a method for heating food, preferably for cooking the food at least in part.

Devices for ohmic heating or cooking of food by passing a current through the electrically conductive food are already known, for example, from U.S. Pat. No. 3,167,000 or 4,642,847. WO 00/76330 A1 describes a system for the continuous production of food products. A method for treating food by ohmic heating arises from EP 3 032 956 B1. A device for pasteurizing a food mass by applying a current having a frequency in the range of 10 MHz to 50 MHz is disclosed in EP 2 895 014 B1; Convexly curved electrodes are used there. As an alternative to ohmic heating, food can be heated by supplying energy by way of heat conduction or electromagnetic radiation.

Though conventional devices and methods have the advantage that the food can be heated or cooked relatively uniformly and homogeneously without it locally overheating or burning, at the same time, however, the performance of conventional devices and methods is limited.

The object of the invention is to provide a device and a method for heating food that allow for a higher productivity compared to conventional devices and methods.

This object is satisfied by a device having the features of claim 1 or by a method for heating food having the features of claim 9. Advantageous further developments of the invention are specified in the dependent claims.

The device according to the invention and the method according to the invention are particularly suitable for heating, possibly even cooking, pasty food, such as sausage meat or pasta. When sausage meat is used as food, pre-cooked or already fully cooked sausage products can be produced during treatment by the device or method of the invention, for example, hot dog sausages or so-called Vienna sausages.

The shaping tube used in the device does not necessarily have to have a circular cylindrical shape. Although it could have a circular internal cross-section, it could also have other shapes, for example oval, square, polygonal, etc. The shaping tube should be made of electrically non-conductive or almost non-conductive material which should also be sufficiently heat-resistant, i.e. should easily withstand temperatures of, for example, 80° C., preferably 100° C. or even more preferably at least 120° C.

The shaping tube should also be mechanically strong enough not to deform even at comparatively high internal pressures. This can be achieved by suitable wall thicknesses of, for example, at least 0.5 cm, preferably at least 1 cm or more preferably at least 1.5 cm.

The shaping tube can comprise transparent material in sections (for example as a window) or overall. This has the advantage that the processes within, in particular an optical change in the food when being heated, can be recognized or monitored visually or using a vision system. In addition or as an alternative to transparent material, the shaping tube can comprise ceramic material at least in sections. It is advantageous to have the material of the shaping tube be wear-resistant and/or have a non-stick effect in terms of the food.

A filling slide is guided to be movable in the shaping tube. This filling slide is ideally shaped such that its outer cross section is congruent but slightly smaller than the inner cross section of the shaping tube. The filling slide can be hollow and in this way be part of a line for feeding the food into a cavity. In this form, the filling slide can be referred to as a filling tube.

Provided in the device are two caps between which the food can be received in a cavity, namely a first cap associated with the filling slide and a second cap disposed opposite the filling slide. Both caps have concave surfaces facing one another between which they define the cavity for receiving the food. “Concave surface” there means that at least part of the surface of the respective cap facing the cavity is concave, although the entire surface of a cap facing the cavity can also be concave. Such concave surfaces have proven to be favorable with regard to the later shape of the finished food and with regard to the heat input into the food.

According to the invention, the device comprises an air valve at the second cap. As shall become clear from the following explanation, this measure has proven to be extremely advantageous with regard to particularly high productivity of the device according to the invention. “Air valve” means that air can be passed through the valve. “At the second cap” in the context of the invention means that the air valve can be arranged in, at or next to the second cap, but in any case on the side of the cavity disposed opposite the filling slide.

The cavity formed between the caps can preferably be evacuated by way of the air valve, i.e. a negative pressure, as compared to the normal pressure, can be generated in the cavity. For this purpose, the device can comprise or be connected to a vacuum source or a vacuum pump in order to be able to cause the evacuation by way of the air valve.

The device can be configured to generate a negative pressure of, for example, 500 mbar, preferably 200 mbar, or even 100 mbar or less in the cavity.

Before the food is introduced into the cavity via the filling slide, the evacuation of the cavity is completed via the air valve at least in part, but preferably completely. This provides the advantage, firstly, that the cavity can be filled with the food more quickly than if the food had to be filled against a normal pressure prevailing in the cavity. Secondly, the lower back pressure in the cavity reduces the energy requirement for filling, and thirdly, the risk of undesired air being incorporated into the food when filling in the food is reduced.

The device can be configured to apply an electrical voltage between the first and second cap, which results in a current flow through the food disposed between the caps. For this purpose, the two caps are preferably configured as electrodes and the device as a heating apparatus comprises its own power source or a connection to an external power source. The device can comprise a control device that is configured to apply the electrical voltage between the two electrodes only at certain times or over certain time intervals. It goes without saying that the food must be electrically conductive in order to be heatable when a current is applied.

A copper alloy has proven to be particularly effective as the material of the electrodes. At least the surface of the electrodes facing the cavity can optionally be coated with a silver layer to improve conductivity and to protect against corrosion; the silver coating preferably has a thickness between 5 micrometers and 20 micrometers.

Alternatively or in addition to ohmic heating, the device can be configured to heat or possibly to cook the food using electromagnetic radiation. In this embodiment, for example, a microwave generator can be provided as the heating apparatus of the device, and the food disposed in the cavity can be exposed to the microwaves generated by the microwave generator.

Additionally or alternatively, the device can be configured to heat the food by way of heat conduction. In this configuration, the heating apparatus can be provided to first heat the shaping tube, for example, in that the heating apparatus comprises heating cartridges embedded in the shaping tube or a heated liquid bath that accommodates the shaping tube, before the shaping tube passes on the heat to the food that is disposed in the cavity.

It is conceivable that compressed air can be supplied via the air valve to the cavity formed between the caps. For this purpose, the device can be equipped or connectable to a source of compressed air. The supply of compressed air into the cavity can support and considerably simplify the removal or ejection of the finished processed food on the side opposite the air valve or can also be used to clean the shaping tube.

Particularly preferred is an embodiment in which the cavity between the caps can be evacuated via the air valve, and air can be supplied to this cavity under normal pressure for ventilation, or compressed air. In this embodiment the air valve therefore has a dual function. If either air under normal pressure or compressed air can be supplied, then the air valve even has a triple function. Already ventilation can provide the advantage of avoiding deformation of the food when the filling slide is retracted.

From a design point of view, it has proven to be advantageous to configure the air valve as a cone valve. Such a cone valve can withstand the required pressures, is small, and can therefore be installed in the shaping tube at least in part as needed. It also enables precise actuation and reliable closure.

The structure of the device becomes particularly simple if the air valve is configured integrally with the second cap. This means that the valve seat (but of course not the valve body that can be moved relative thereto) is formed integrally with the second cap. In this way, the number of components of the device is reduced.

It has proven to be expedient to have the second cap be arranged in a stationary manner with respect to the shaping tube. In this way, the second cap can be secured particularly firmly; it can serve as a counter bearing for the ejection pressure, in particular when the treated food is ejected.

In an alternative embodiment, the second cap is mounted to be movable relative to the shaping tube. This allows the second cap (which can optionally be configured as a second electrode) to be displaced relative to the shaping tube to create an opening in the cavity through which the food can be ejected after it has been heated.

The filling slide can preferably be completely moved out of the shaping tube. This makes it possible to discharge the processed food through the same opening through which the filling slide can be inserted into the shaping tube. It is expedient to have the filling slide also be suitably guided or mounted in a position that is completely moved out of the shaping tube so that it maintains an axial alignment relative to the shaping tube or can reliably assume it again in order to be able to return comparatively quickly and safely after the food has been discharged in order to be able to be introduced into the shaping tube again.

In an advantageous embodiment, the filling slide comprises a shut-off filling valve. It is only open as long as the food is filled into the cavity by the filling slide. Shutting off can ensure that a predetermined maximum volume of food is always filled into the cavity.

It is conceivable that the filling slide is configured as a hollow filling tube. Alternatively, the filling slide could also have a substantially U-shaped cross section with a filling groove on its outer side. However, the configuration as a hollow filling tube has the advantage of being easier to shut off.

The device can comprise a collet which can be mounted, for example, to the shaping tube and in which the filling slide can be temporarily affixed or clamped. For this purpose, the collet can comprise two clamping jaws that are movable relative to one another. This provides the advantage of being able to at least temporarily affix the filling slide in a stationary manner with respect to the shaping tube while the food is being heated. This prevents the filling slide from being moved outwardly too early due to the internal pressure of the food and the food being destroyed in the process.

It is particularly favorable to have the collet be configured to be electrically conductive. This makes it possible, for example, to supply a current to a first cap configured as an electrode and provided at the filling slide if the food is to be heated by ohmic heating. The collet can be used for the local transfer of electricity and heat (heating integrated in the clamping jaws) to the cap (electrode) of the filling slide. Positioning and holding the filling slide can be carried out or supported by an external mechanical stop that can be activated.

The device can comprise an ejector as a further component. It can be configured to be rod-shaped. The ejector can be used to push the food out of the shaping tube after the food has been heated and both the first cap as well as the second cap have been removed from the shaping tube. The ejector can optionally comprise a flexible cleaning lip for mechanically cleaning the inner wall of the shaping tube when the food is ejected from the shaping tube.

In the method according to the invention for heating, possibly cooking or boiling, food, the food is filled via a filling slide into a cavity in a shaping tube and then heated completely or at least locally. This method can be carried out with a device in one of the variants described above. According to the invention, it is provided that the cavity is evacuated via an air valve before the food is filled into this cavity, i.e. that a negative pressure is generated in the cavity in comparison to the normal pressure. This facilitates filling the food and reduces energy demand because of the lower resistance; at the same time, undesired air being incorporated into the food and possibly the formation of steam bubbles are prevented or at least greatly reduced.

The filling slide is preferably displaced within the shaping tube while the cavity is being filled with the food. This displacement is caused by a filling pressure of the food that fills the cavity, i.e. by a kind of recoil effect. To avoid stick-slip effects, the motion of the filling slide can be adjusted by way of a throttle valve. The advantage of displacing the filling slide while filling the cavity is that the cavity can initially be kept comparatively small and can be evacuated quickly in this way, which increases productivity.

It has proven to be expedient to have the filling pressure of the food that fills the cavity be comparatively high and be at least 10 bar, preferably even at least 15 bar, more preferably in the range from 15 bar to 25 bar. These pressures can cause the cavity to quickly fill as well as the filling slide to be pushed out of the shaping tube. In embodiments, this pushing out is even possible without the need for an active drive for displacing the filling slide out of the shaping tube.

The filling slide can preferably be moved completely out of the shaping tube so that the food can be discharged from the shaping tube. In this way, the filling slide quasi releases the opening through which the food can be discharged after heating.

Discharging or quasi ejecting the food from the shaping tube can be effected or at least supported by supplying compressed air into the cavity. Avoiding mechanical components for discharge or ejection makes the device less complex and facilitates cleaning.

It is particularly favorable to have the compressed air used for discharge be supplied to the cavity via the air valve used for evacuation. It therefore has a dual function both for evacuating and for supporting the discharge of the food from the cavity.

In one embodiment, a collet can be provided, by way of which the filling slide is affixed at least temporarily in a certain position while the food is being heated. The collet can optionally be electrically conductive and can be used in this way to supply an electrical current to and through the food in order to heat it by way of ohmic heating.

In a variant of the method, for example, a rod-shaped ejector is used to mechanically push the heated food out of the shaping tube. In this case, it is expedient to have the two caps be removed from the shaping tube prior to the pushing out process. The ejector can optionally comprise a flexible cleaning lip for mechanically cleaning the inner walls of the shaping tube when the food is pushed out.

As already stated in the introduction, the food can be, for example, a pasty mass or so-called forcemeat, for example, dough or sausage meat.

The electrical voltages used between the two electrodes in the option with ohmic heating in the device according to the invention and in the method according to the invention are preferably in the range from 150V to 650V. The amperage during the treatment of food reaches values of e.g. 1 to 5 A; the power during heating can be 0.5 to 2.5 KW, preferably 1 to 1.5 KW. Periods of, for example, 10 s to 45 s have proven to be favorable as a duration for the treatment of food by ohmic heating. Which values are optimal depends, for example, on the type of food and, if applicable, its consistency and/or degree of moisture.

It is to be noted at this point that all features described in the context of the device also apply to the method according to the invention and its variants, and conversely the features described in the context of the method can also be applied to the device.

Advantageous embodiments of the invention are illustrated in more detail hereafter with reference to a drawing, where:

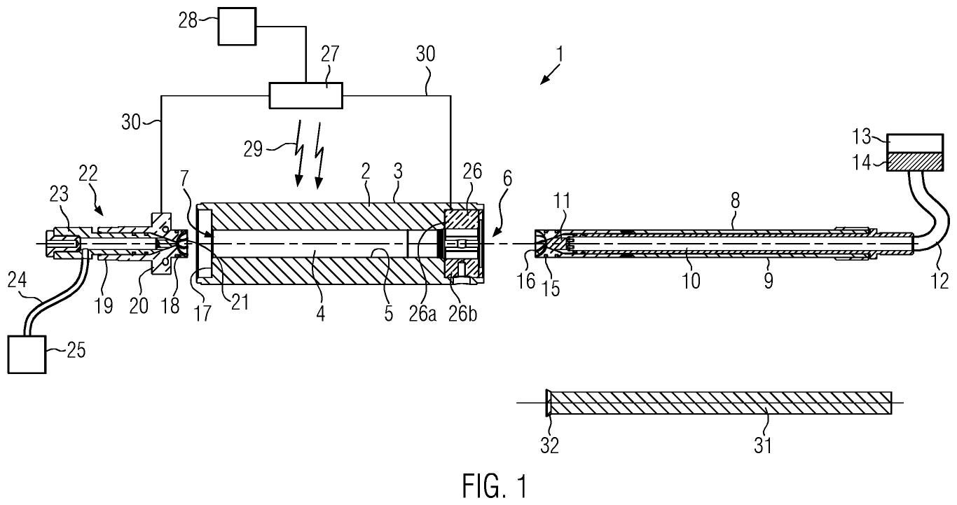

FIG. 1 shows a schematic illustration of important components of a first embodiment of the device according to the invention.

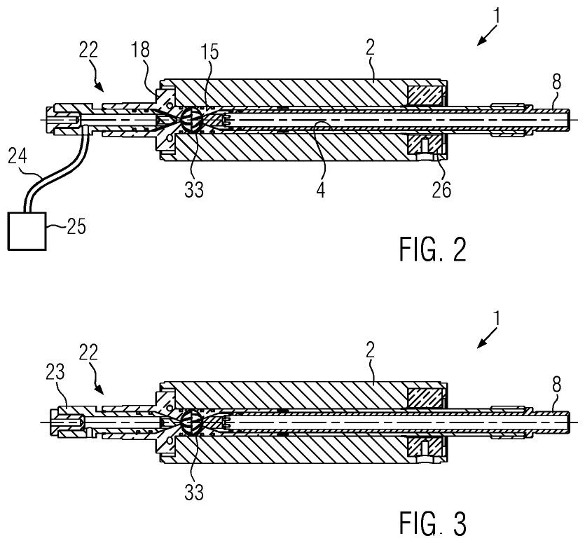

FIG. 2 shows the embodiment of FIG. 1 in a first state,

FIG. 3 shows the embodiment of FIG. 1 in a second state,

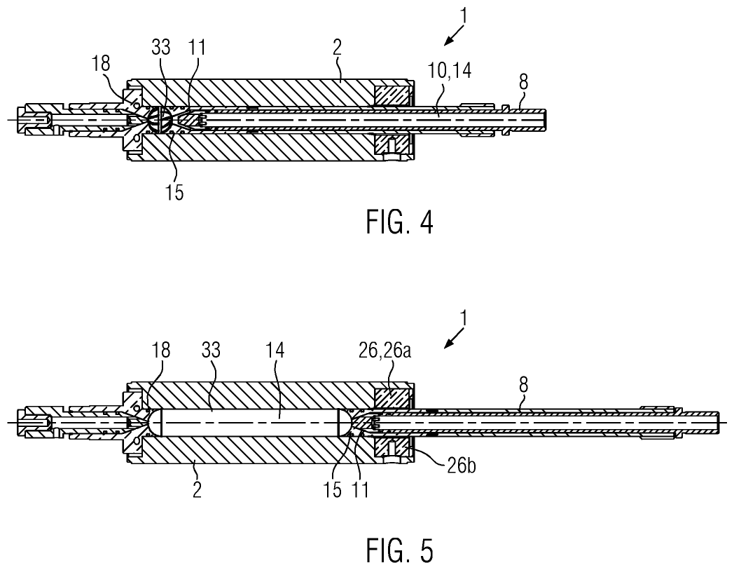

FIG. 4 shows the embodiment of FIG. 1 in a third state,

FIG. 5 shows the embodiment of FIG. 1 in a fourth state,

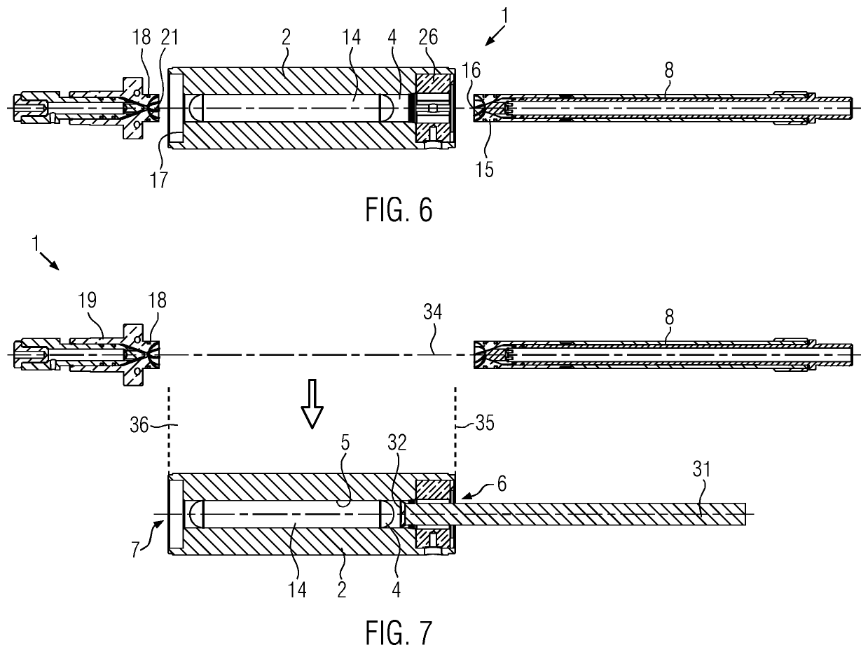

FIG. 6 shows the embodiment of FIG. 1 in a fifth state,

FIG. 7 shows the embodiment of FIG. 1 in a sixth state,

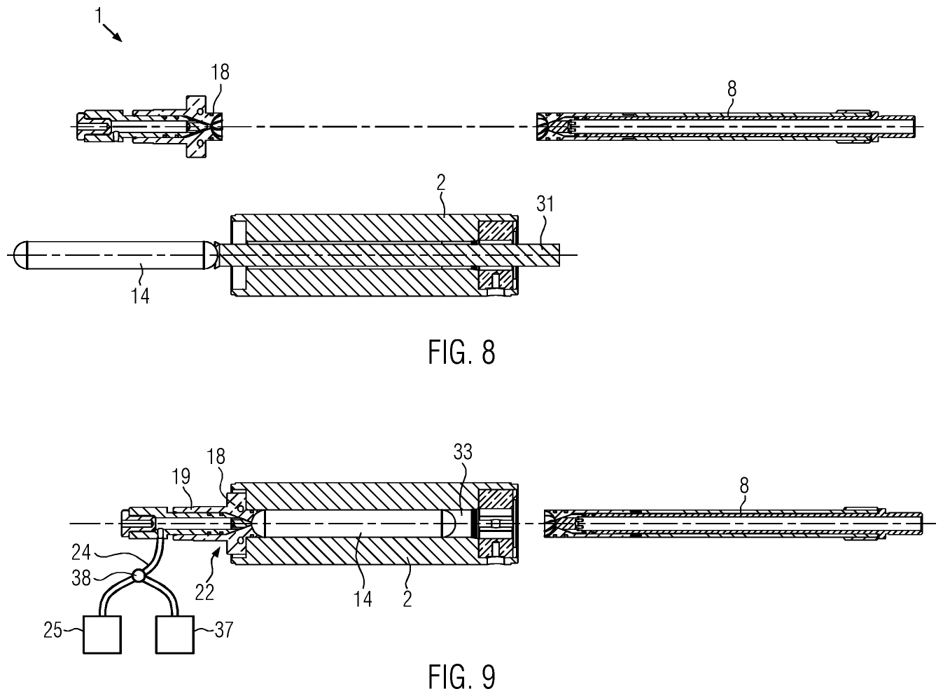

FIG. 8 shows the embodiment of FIG. 1 in a seventh state,

FIG. 9 shows a second embodiment of a device according to the invention in a first state,

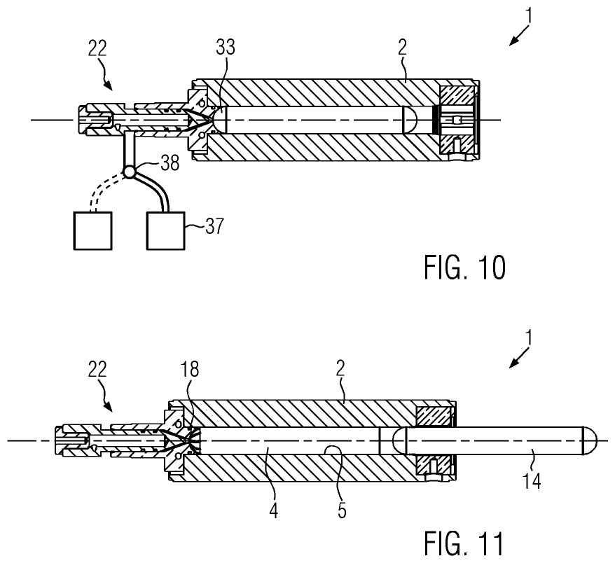

FIG. 10 shows the embodiment of FIG. 9 in a second state and

FIG. 11 shows the embodiment of FIG. 9 in a third state. Identical or corresponding components are provided with the same reference characters throughout the figures. Though the components of the device and parameters described hereafter together enable the highest increase in productivity when operating the device, they can also represent independent inventions individually or in any sub-combination.

FIG. 1 shows a simplified schematic illustration of individual components of various embodiments of a device 1 according to the invention for heating food. Device 1 comprises a shaping tube 2. It can have a substantially cylindrical outer surface 3 and be made from electrically non-conductive material, in particular made completely or at least in sections from transparent material, such as Plexiglas. It is also conceivable for shaping tube 2 to be formed from ceramic. Shaping tube 2 has an interior 4 which is defined by an inner wall 5. In the present embodiment, a central section of interior 4 is likewise cylindrical, but interior 4 can also have any other cross-sectional shape. In the present embodiment, interior 4 can have a diameter of, for example, 0.5 cm to 4 cm, but larger values are also conceivable. Interior 4 comprises a first opening 6 and a second opening 7, respectively, at its ends.

A filling slide 8 is movable relative to shaping tube 2 and is provided to be inserted at least in sections into interior 4 of shaping tube 2. Preferably, an outer contour of filling slide 8 is configured to be congruent to the cross section of interior 4 of the shaping tube, but is sized minimally smaller than the cross section of interior 4 in order to seal interior 4 at first opening 6, but still can be moved comparatively easily in interior 4. In the present embodiment, outer contour 9 of filling slide 8 can therefore be circular.

In the present embodiment, filling slide 8 is configured as a filling tube, i.e. with a line 10 in its interior which is closed at a distal end (in FIG. 1: to the left) by a filling valve 11 which is presently configured by way of example as a cone valve. Filling slide 8 is in communication via a schematically indicated, for example, flexible feed line 12 with a reservoir 13 in which food 14 to be heated is received. Food 14 can be pasty, for example, a dough or sausage meat. Food 14 can be conveyed via the feed line to filling slide 8 using a suitable conveying device, such as a pump (not shown).

At its distal end (in FIG. 1: to the left) filling slide 8 comprises a first cap 15. Cap 15 comprises a concave surface 16 facing interior 4. The opening of filling valve 11 is disposed approximately at the center of concave surface 16.

Shaping tube 2 comprises a step 17 in the region of second opening 7. A second cap 18 having a cap body 19 can be inserted into step 17. Cap body 19 comprises a flange 20 which can be inserted into step 17. Second cap 18 comprises a concave surface 21 which faces interior 4 of shaping tube 2 or concave surface 16 of filling slide 8, respectively.

A valve element 23 forming an air valve 22 at second cap 18 is mounted to be movable in cap body 19. In the present embodiment, air valve 22 is configured as a cone valve, the opening of which is disposed approximately at the center of concave surface 21 of second cap 18. An air line 24 connects air valve 22 to a vacuum source 25, for example, to a vacuum pump.

A collet 26 is arranged in shaping tube 2 in the region of first opening 6. Collet 26 comprises two clamping jaws 26a, 26b which can be moved relative to one another between an open position and a clamping position. In the open position, the spacing between clamping jaws 26a, 26b is large enough to allow filling slide 8 to pass between them.

As a further component, device 1 comprises a heating apparatus 27 which can be connected to a control device 28 of device 1. Heating apparatus 27 is used to provide energy for heating food 14 that is disposed in shaping tube 2. For this purpose, heating apparatus 27 can be configured in different ways. For example, it can be a microwave generator that generates microwave radiation 29 and directs it onto food 14 that is disposed in shaping tube 2. Alternatively, the heating apparatus can be or comprise a liquid bath in which shaping tube 2 is embedded to absorb heat, and/or heating apparatus 27 can comprise electrical resistance heating elements which abut against shaping tube 2 or can be embedded in the wall of shaping tube 2. In a further embodiment, heating apparatus 27 can have or comprise a power source and—as explained in detail hereafter—be configured for ohmic heating of the food that is disposed in shaping tube 2. In this embodiment, first cap 15 and second cap 18 are each configured as first and second electrodes, i.e. made of electrically conductive material. The concave surface 16, 21 of first and second electrodes 15, 18 can optionally be provided with a coating, for example, made of silver. In this embodiment, collet 26 and filling slide 8 are preferably also electrically conductive or formed from electrically conductive material, and power lines 30 are run from heating apparatus 27 to second cap 18 or to collet 26, respectively.

As a further component, the device disposes of a substantially rod-shaped ejector 31. It comprises a ring-shaped cleaning lip 32 formed from flexible material. Cleaning lip 32 is sized such that it enables mechanical cleaning of inner wall 5 of interior 4 of shaping tube 2 when ejector 31 is pushed from the right to the left through interior 4.

For the sake of clarity, some components of device 1 are no longer shown in FIG. 2. Device 1 is in a first state. Filling slide 8 is inserted as far as possible into interior 4 of shaping tube 2. Collet 26 is disposed in its open position. Second cap 18 is inserted into step 17 at second opening 7 of shaping tube 2. First and second cap 15, 18 touch one another or are only spaced by a minimal distance from one another. Concave surfaces 16, 21 of two caps 15, 18 form a cavity 33 between two caps 15, 18.

Air valve 22 is in its open position in which valve element 23 is retracted towards the left. Vacuum source 25 ensures via air line 24 that cavity 33 is evacuated via air valve 22. The air pressure in cavity 33 can be reduced to a value of less than 500 mbar, preferably less than 200 mbar, or even less than 100 mbar.

FIG. 3 shows device 1 in a second state. Starting out from the first state shown in FIG. 2, air valve 22 has been closed in that valve element 23 of air valve 22 configured as a cone valve has been moved to the right into its valve seat. This completes the evacuation of cavity 33. This provides the advantage that the subsequent filling of cavity 33 with food 14 is counteracted by a considerably lower resistance; in addition, the risk that air contained in cavity 33 is incorporated into food 14 when the cavity is filled and forms undesirable bubbles there, which could possibly burst when the food is heated or cooked and could destroy the food, is reduced.

FIG. 4 shows device 1 in a third state, namely at the beginning of filling cavity 33 with food. In this state, filling valve 11 is open. The (usually pasty) food 14 is delivered from reservoir 13 via feed line 12 to filling slide 8. Food 14 is filled through line 10 inside filling slide 8 and via filling valve 11 into cavity 33 under very high pressure of, for example, 10 bar to 25 bar. The internal pressure of food 14 within cavity 33 acts as a drive for filling slide and moves filling slide 8 to the right hand side because first cap 18 is affixed relative to shaping tube 2 more firmly than filling slide 8. It can be seen in FIG. 4 that a (small) spacing has already formed between first cap 15 and second cap 18. Of course, cavity 33 is no longer empty from the beginning of being filled with food 14; it can even (and usually will) be completely filled with food 14. Even if the spacing between two caps 15, 18 is filled completely or in part, the term “cavity” 33 in the context of the invention shall be used for reasons of consistency.

FIG. 5 shows device 1 in a fourth state in which the filling of cavity 33 with food 14 is completed. The entire space between first cap 15 and second cap 18 is filled with food 14. Filling valve 11 at filling slide 8 is shut off. Clamping jaws 26a, 26b of collet 26 are made to assume the closed position in which they clamp filling slide 8 between them and thereby affix it in a stationary manner with respect to shaping tube 2.

In this state, heating of food 14 can be performed. As explained above, heating apparatus 27 is used to supply heat to the portion of food 14 contained in cavity 33. This can be done by way of heat conduction via shaping tube 2, by supplying electromagnetic radiation, for example, microwave radiation 29, or by ohmic heating, in that an electrical voltage is applied via collet 26 and electrically conductive filling slide 8 between first and second caps 15, 18 that are configured as electrodes. A current flows through food 14, which is also electrically conductive, and is converted into heat by the electrical resistance of food 14 which heats food 14 at least locally, preferably completely and homogeneously. “Heating” is to mean that the temperature of the food increases, for example, by at least 5° C., whereby food 14 can also optionally be cooked. The electrical voltage between two caps 15, 18 that are configured as electrodes can be, for example, between 150V and 650V and can be applied for a period of, for example, 5 s to 45 s.

FIG. 6 shows the device in a fifth state. Starting out from the state shown in FIG. 5, collet 26 has been made to assume its open position. Filling slide 8 has been moved to the right hand side and completely removed from shaping tube 2. The assembly with second cap 18 has also been moved out of step 17 and completely removed from shaping tube 2. Heated food 14 is still disposed in interior 4 of shaping tube 2. The shape of the ends of food 14 is determined by concave surfaces 16, 21 of caps 15, 18 or corresponds to the shape of these surfaces 16, 21, respectively.

FIG. 7 shows device 1 in a sixth state. Once filling slide 8 and the assembly with second cap 18 have been removed from shaping tube 2, shaping tube 2 has been moved out of alignment 34 of filling slide 8 and second cap 18. One option to do this is that shaping tube 2 is mounted in a guide 35 and is offset along the guide relative to filling slide 8. Another option is that shaping tube 2 (or a plurality of such shaping tubes 2) is arranged on a carrier 36, for example, a rotatable drum 36, and has been moved out of alignment 34 by way of the latter. Another option is that shaping slider 8 and the assembly with second cap 18 are moved while shaping tube 2 remains stationary.

Interior 4 of shaping tube 2 is now aligned with ejector 31. The latter is inserted through first opening 6 into the interior of shaping tube 2. When ejector 31 moves to the left hand side, cleaning lip 32 swipes along inner wall 5 of interior 4 and thus cleans inner wall 5. Second opening 7 is free or open, respectively.

FIG. 8 shows device 1 in a seventh state. Starting out from the state in FIG. 7, ejector 31 has been moved so far through interior 4 of shaping tube 2 that cleaning lip 32 at the distal end of ejector 31 has exited from second opening 7 of shaping tube 2. In this way, heated (or cooked) food 14 is ejected or discharged from shaping tube 2. As a result, device 1 or the method, respectively, produces a heated, pre-cooked, or even cooked food such as a sausage, for example, a hot dog sausage, or a stick (pre-) baked from dough.

Following the discharge of food 14, device 1 can again return to the first state shown in FIG. 2; the cycle begins anew.

FIG. 9 shows a further embodiment of a device 1 according to the invention. Unlike the first embodiment, cap body 19 with second cap 18 is stationary relative to shaping tube 2. Cap body 19 can be firmly mounted at shaping tube 2 for this purpose.

As a further difference, air valve 22 can be connected via air line 24 not only to a vacuum source 25, but also selectively to a compressed air source 37. Instead of compressed air source 37, element 37 can simply be a connection to the ambient air (normal pressure). A directional control valve 38 can be actuated by control device 28 and ensures that air valve 22 is always fluidly connected only either to vacuum source 25 or to compressed air source 37.

The filling and heating of food 14 is carried out analogously to the first embodiment, including the evacuation of cavity 33 before food 14 is filled via filling slide 8. FIG. 9 shows device 1 in a state in which the heating of food 14 has been completed and filling slide 8 has been completely removed from shaping tube 2. FIG. 10 shows the embodiment according to FIG. 9 in a second state. Starting out from the state shown in FIG. 9, air valve 22 has been opened and connected via directional control valve 38 to compressed air source 37 or to the ambient air under normal pressure, respectively. Air or compressed air is therefore passed into cavity 33 via air valve 22 in second cap 18.

As shown in FIG. 11, the compressed air ensures that heated food 14 is discharged or ejected to the right hand side out of shaping tube 2. Second cap 18 or its cap body 19, respectively, serves as a counter bearing since they are connected in a stationary manner to shaping tube 2. At the same time the compressed air can have a cleaning effect on inner wall 5 of interior 4.

Based on the embodiments illustrated and described, the device according to the invention and the method according to the invention can be amended in many ways. For example, it is conceivable in the second embodiment that compressed air source 37 and directional control valve 38 can be dispensed with if ventilating cavity 33 via air valve 22 with normal pressure is already sufficient to discharge food 14—as shown in FIG. 11—from shaping tube 2. Air valve 22 can, but does not have to be, formed integrally with cap body 19. For example, it could also be arranged adjacent to cap 18 in the wall of shaping tube 2. With higher temperatures or longer treatment times, items in cavity 33 could also be sterilized.

1. Device for heating food, comprising
a shaping tube made from electrically non-conductive material,
a filling slide guided to be movable in said shaping tube,
a first cap associated with said filling slide,
a second cap,
wherein said first and said second cap each have concave surfaces facing one another between which they define a cavity,
wherein said food can be fed to said cavity via said filling slide, and
wherein said device comprises a heating apparatus which is configured to heat said food that is disposed in said cavity,
wherein said device comprises an air valve at said second cap.

2. Device according to claim 1, wherein said cavity formed between said caps can be evacuated via said air valve.

3. Device according to claim 1, wherein air under normal pressure or compressed air can be supplied via said air valve to said cavity formed between said caps.

4. Device according to claim 1, wherein said air valve is configured as a cone valve.

5. Device according to claim 1, wherein said air valve is formed integrally with said second cap.

6. Device according to claim 1, wherein said second cap is arranged in a stationary manner with respect to said shaping tube.

7. Device according to claim 1, wherein said filling slide can be moved completely out of said shaping tube.

8. Device according to claim 1, wherein said first and said second cap are each configured as electrodes and said heating apparatus is configured to apply an electrical voltage between said first and said second electrode.

9. Method for heating food, wherein food is filled via a filling slide, which is guided to be movable in a shaping tube, into a cavity which is defined by a first and a second cap each comprising concave surfaces facing one another, and wherein, once said food has been filled into said cavity, said food disposed in said cavity is heated by way of a heating apparatus at least locally, wherein said cavity is evacuated via an air valve before said food is filled into said cavity.

10. Method according to claim 9, wherein said filling slide is displaced within said shaping tube while said cavity is filled with said food.

11. Method according to claim 9, wherein a filling pressure of said food filling said cavity is at least 10 bar.

12. Method according to claim 9, wherein said filling slide is moved completely out of said shaping tube for discharging said food from said shaping tube.

13. Method according to claim 9, wherein said food is discharged from said shaping tube by, or supported by supplying compressed air, into said cavity.

14. Method according to claim 9, wherein said first and said second cap are each configured as electrodes and in that an electrical current is generated through said food by applying an electrical voltage between said first and said second electrode.

15. Method according to claim 9, wherein a collet is provided and affixes said filling slide at least temporarily while said food is being heated.

16. Device according to claim 7, wherein said filling slide comprises a shut-off filling valve.

17. Method according to claim 10, wherein said displacement is at least caused by a filling pressure of said food filling said cavity.

18. Method according to claim 13, wherein the compressed air is supplied to said cavity via said air valve that is used for evacuation.
